(19) United States
(12) Patent Application Publication
(10) Pub. No.: US 2025/0087382 A1
(43) Pub. Date: Mar. 13, 2025

(54) INSULATION COMPOSITION FOR HIGH-VOLTAGE CABLE, HIGH-VOLTAGE CABLE MADE FROM THE SAME AND VEHICLE COMPRISING THE SAME CABLE

(71) Applicants: Hyundai Motor Company, Seoul (KR); Kia Corporation, Seoul (KR); Kyungshin Cable, Cheonan-Si (KR); Taesung Ecomps, Cheonan-Si (KR)

(72) Inventors: Yun Jae Jung, Hwaseong-Si (KR); Seung Min Yoo, Hwaseong-Si (KR); Byeong Kyu Kim, Hwaseong-Si (KR); Young Jong Lee, Hwaseong-Si (KR); In Ho Kim, Seoul (KR); Yeong Ju Lee, Cheonan-Si (KR); Jung Woo Park, Cheonan-Si (KR)

(21) Appl. No.: 18/921,606

(22) Filed: Oct. 21, 2024

(30) Foreign Application Priority Data
Sep. 7, 2023 (KR) 10-2023-0119177
Jun. 4, 2024 (KR) 10-2024-0073221

(51) Int. Cl. H01B 3/42; C09D 5/18; C09D 7/48; C09D 7/61; C09D 7/63; C09D 123/08; H01B 7/295

(52) U.S. Cl. CPC H01B 3/425; C09D 5/18; C09D 7/48; C09D 7/61; C09D 7/63; C09D 123/0853; C09D 123/0869; H01B 7/295

(57) ABSTRACT

An insulation composition for a high-voltage cable according to an example of the present disclosure includes a base resin, a flame retardant, a cross-linking agent, and other additives. Here, the base resin includes 30 to 60 wt % of a polar ethylene-based copolymer, 20 to 50 wt % of ethylene-propylene rubber or ethylene alpha-olefin, and 10 to 20 wt % of maleic anhydride-modified ethylene-vinyl acetate.

### CROSS-REFERENCE TO RELATED APPLICATIONS

The present application claims priority to Korean Patent Application No. 10-2023-0119177, filed on Sep. 7, 2023 and Korean Patent Application No. 10-2024-0073221, filed on Jun. 4, 2024, the entire contents of which is incorporated herein for all purposes by this reference.

### TECHNICAL FIELD

The present disclosure relates to an insulation composition for a high-voltage cable, the high-voltage cable made from the same, and a vehicle including the same cable.

### BACKGROUND

A high-voltage cable is increasingly used for an eco-friendly vehicle. The high-voltage cable generally uses a cross-linked polyethylene (XLPE) composition having an excellent insulation resistance performance as an insulation material.

The XLPE is a material in which polyethylene (PE) is cross-linked by mixing the PE with an organic vulcanizing agent using cross-linking equipment to make a structure of the PE into a cross-linked state and apply a thermosetting viscoelastic property to the PE. XLPEs have excellent electrical properties, a high insulation strength, a low dielectric constant relative to a volume resistance, and excellent heat resistance and aging resistance.

The insulation material is preferably flexible, lightweight, and compact for energy efficiency.

Although a typical XLPE high-voltage cable complies with a ‘thick wall insulation’ structure of (International Organization for Standardization (ISO) 19642 that is the international standard for automotive wires, the typical XLPE high-voltage cable may not comply with a ‘thin wall insulation of ISO 19642 due to abrasion resistance and insulation resistance.

That is, although the typical XLPE cable satisfies a mechanical and electrical performance for the ‘thick wall insulation’ specification, with thick insulation/sheath thickness, the typical XLPE cable has a disadvantage in weight reduction and miniaturization due to a heavy weight and a large outer diameter thereof. Also, the typical XLPE cable has a disadvantage in flexibility and harness workability.

Also, a sheath material requires extrudability because productivity of cable manufacturing is improved by maximizing an extrusion speed.

Also, a cable for a vehicle requires a materials property of eco-friendly flame retardant according to an eco-friendly trend.

Environmentally harmful substances such as halogens and heavy metals are excluded as a global trend. Since brominated flame retardants (DBDPO) are considered as dioxin-generating substances, the DBDPO is prohibited in use in some European countries.

Thus, halogen-free materials including metal hydroxides such as aluminum hydroxide (Al(OH)₃) and magnesium hydroxide (Mg(OH)₂) or phosphorus-based flame retardants may be alternatives, and since regulations on toxicity, corrosive gas, and smoke generation during combustion are strengthened in addition to a flame retardant property of a wire, research on eco-friendly cables is being performed, although manufacturing costs of such cables are increased.

The above-described content is merely background information to aid in understanding the present disclosure and does not necessarily imply that the technology was publicly available prior to the present disclosure. Thus, at least the above-described content should not be used as publicly disclosed technology for determining the novelty or inventive step of the present disclosure.

### SUMMARY

The following summary presents a simplified summary of certain features. The summary is not an extensive overview and is not intended to identify key or critical elements.

Insulation compositions, cables and vehicles using said insulation compositions are described herein. An insulation composition for an electrical cable may comprise a base resin, a flame retardant, a cross-linking agent, and at least one other additive. The base resin may comprise: 30 to 60 wt % of a polar ethylene-based copolymer, 20 to 50 wt % of ethylene-propylene rubber or ethylene alpha-olefin, and 10 to 20 wt % of ethylene-vinyl acetate modified with maleic anhydride.

An electrical cable may comprise an electrical conductor wire; and a sheath that surrounds the electrical conductor wire. The sheath may be made from an insulation composition comprising: a base resin, a flame retardant, and a cross-linking agent. The base resin may comprise 30 to 60 wt % of a polar ethylene-based copolymer, 20 to 50 wt % of ethylene-propylene rubber or ethylene alpha-olefin, and 10 to 20 wt % of ethylene-vinyl acetate modified with maleic anhydride.

A vehicle may comprise a battery; and an electrical cable electrically connected to the battery. The electrical cable may comprise an electrical conductor wire and a sheath that surrounds the electrical conductor wire. The sheath may be made from an insulation composition comprising: a base resin, a flame retardant, and a cross-linking agent. The base resin may comprise 30 to 60 wt % of a polar ethylene-based copolymer, 20 to 50 wt % of ethylene-propylene rubber or ethylene alpha-olefin, and 10 to 20 wt % of ethylene-vinyl acetate modified with maleic anhydride.

These and other features and advantages are described in greater detail below.

### BRIEF DESCRIPTION OF THE DRAWINGS

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, the same reference numerals refer to the same or equivalent parts of the present disclosure throughout the several figures of the drawing.

FIG. 1 is a table showing constituents and properties of examples and comparative examples of the present disclosure.

FIGS. 2 and 3 are tables showing comparison of properties of example 1 and comparative example 1.

FIG. 4 is a view showing a high-voltage cable according to an example of the present disclosure.

### DETAILED DESCRIPTION

Since the present disclosure allows for diverse modifications, variations and/or replacements, certain examples are illustrated in the drawings and are described in detail in the disclosure. However, these examples do not limit the present disclosure and it should be understood that the present disclosure covers all the modifications, equivalents, and replacements within the idea and technical scope of the present disclosure.

In this specification, the suffixes “module” and “unit”” are used merely for nominal distinction between components and should not be interpreted as implying that the components are physically or chemically separated or that they may be separated.

It will be understood that although the terms of “first” and “second” are used herein to describe various elements, these elements should not be limited by these terms. These terms may be used solely to differentiate one component from another in name, and their sequential meanings are understood through the context of the description rather than by the names themselves.

The term “and/or” is used to include all possible combinations of the listed items. For example, “A and/or B” includes all three cases of “A”, “B”, and “A and B”.

It will also be understood that when an element is referred to as being “connected to” or “engaged with” another element, it may be directly connected to or engaged with the other element, or indirectly connected to or engaged with, wherein one or more intervening elements may also be present.

In the following description, the technical terms are used only for explaining a specific example while not limiting the present disclosure. Terms of a singular form may be considered to also include plural forms, unless referred to the contrary. The terms “include”, “has” and “comprise” mean that a property, a region, a fixed number, a step, a process, an element and/or a component is present, but does not exclude other properties, regions, fixed numbers, steps, processes, elements and/or components.

Unless terms used in the present disclosure are defined differently, the terms may be construed as meaning known to those skilled in the art. Terms that are generally used and/or are defined in dictionaries should be construed as having meanings matched with contextual meanings in the art. In this description, unless defined clearly, terms are not ideally, excessively construed as formal meanings.

An insulation composition for a high-voltage cable according to an example of the present disclosure includes a base resin, a flame retardant, a cross-linking agent, and other additives.

The base resin may include about 30 to about 60 wt % of a polar ethylene-based copolymer, about 20 to about 50 wt % of ethylene-propylene rubber or ethylene alpha-olefin (e.g., resin), and about 10 to about 20 wt % of an ethylene-vinyl acetate copolymer modified with maleic anhydride (MaH).

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method.

The polar ethylene-based copolymer may include an ethylene copolymer containing (e.g., about 15 to about 50 wt % of) a polar monomer. That is, the polar ethylene-based copolymer may include ethylene butyl acrylate (EBA), ethylene ethyl acrylate (EEA), ethylene vinyl acetate (EVA), or a combination of these.

If a content of the polar monomer in the polar ethylene-based copolymer is less than about 15 wt %, flexibility and/or flame retardancy may be degraded. If the content of the polar monomer in the polar ethylene-based copolymer is greater than about 50 wt %, tensile strength and/or abrasion resistance may be degraded.

A melting point of the polar ethylene-based copolymer resin included in the base resin may be in a range from 40 to 120° C.

The ethylene alpha-olefin may be selected from the group consisting of 1-butene, 1-octene, 1-pentene, 11-hexene, 1-heptene, 4-methyl-1-pentene, 6-methyl-1-heptene, and a combination thereof.

The polar ethylene resin alone in the insulation composition may have insufficient insulation resistance. Low-density polyethylene (LDPE) may be mixed added to the polar ethylene resin to improve insulation resistance, but this may reduce flexibility and degrade flame retardancy because the content of the flame retardant decreases. In an example, an ethylene-alpha olefin copolymer that is more flexible and has better processability than LDPE is may be added in addition to or instead of the LDPE.

If the content of the ethylene-alpha olefin copolymer is less than about 20 wt %, flexibility and insulation resistance properties may be insufficient. If the content of the ethylene-alpha olefin copolymer is greater than about 50 wt %, mechanical properties may be degraded.

Also, about 10 to about 20 wt % of a resin modified by polymerizing maleic anhydride onto an ethylene-vinyl acetate resin may be added to the base resin in order to improve mechanical properties and abrasion resistance

This modified resin increases intermolecular force between the inorganic flame retardant and a polymer of the base resin to improve mechanical strength. If the content is less than about 10 wt % resin modified by polymerizing maleic anhydride onto an ethylene-vinyl acetate resin, the intermolecular force may decrease to degrade physical properties, and when the content is greater than about 20 wt % resin modified by polymerizing maleic anhydride onto an ethylene-vinyl acetate resin, the intermolecular force may increase so much as to reduce elongation and flexibility.

An inorganic flame retardant may be further added in the ethylene-based base resin to satisfy requirements of high flame retardancy.

The inorganic flame retardant may include a metal hydroxide or a phosphorus-based flame retardant. In an example, the flame retardant is a metal hydroxide.

A content of the inorganic flame retardant may be in a range from 50 to 150 parts by weight based on 100 parts by weight (parts per hundred, or phr) of the base resin. If the content is less than 50 parts by weight, the flame retardancy may be insufficient. If the content is greater than 150 parts by weight, the processability, such as extrusion speed, may decrease, and flexibility and abrasion resistance may be degraded.

A content of the cross-linking agent may be in a range from 1 to 10 parts by weight based on 100 parts by weight of the base resin, and preferably from 1 to 5 parts by weight.

If the content is less than 1 part by weight cross-linking agent, properties such as heat resistance and flame retardancy may be degraded due to insufficient cross-linking. If the content is greater than 10 parts by weight cross-linking agent, properties such as flexibility and low-temperature resistance may be degraded due to excessive cross-linking.

Also, or alternatively, an antioxidant may be added to the insulation composition to prevent oxidation, such as caused by heat or ultraviolet rays. Preventing oxidation may extend a lifespan of the cable. A phenol-based antioxidant may be used alone, or a mixed antioxidant including an amine or thioester antioxidant may be used.

If a content of the antioxidant is too low, an antioxidation capability may be insufficient to shorten a lifespan of the insulation composition and the cable. if the content is too high, the antioxidant may degrade properties such as flame retardancy of the insulation composition.

A slip agent may be added to improve processability and dispersibility. For example, a condensation product of a fatty acid derivative and an organic siloxane may be used as the slip agent.

Silicon gum may provide extrusion moldability and/or flame retardancy. The silicon gum may thereby improve dispersibility and surface activity, thereby improving abrasion resistance.

The composition according to an example of the present disclosure may include: , as the base resin, 30 to 60 phr of polar ethylene-based copolymer resin; 20 to 50 phr of ethylene-alpha olefin resin; and 10 to 20 phr of maleic anhydride-modified ethylene-vinyl acetate, and may further include 50 to 100 phr of an inorganic flame retardant, 1 to 10 phr of a cross-linking agent, 2 to 5 phr of an antioxidant, and 1 to 5 phr of a slip agent.

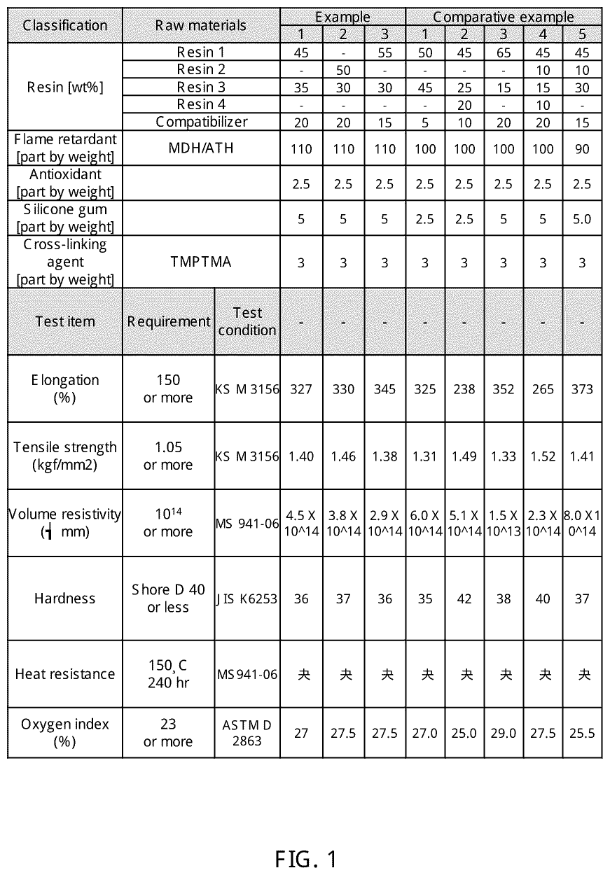

Hereinafter, material properties of examples and comparative examples of the present disclosure will be described with reference to FIGS. 1 to 3.

First, constituents of compositions of examples shown in FIG. 1 are as follows:
Resin1: EVA (VA 28 wt %, Tm 75° C.)
Resin2: EEA (EA 23 wt %. Tm 94° C.)
Resin 3: Polyolefin Elastomer (POE) (1-Butene, Tm 45° C.)
Resin 4: Low Density Polyethylene (LDPE) (Tm 110° C.)
Compatibilizer: MaH-EVA (VA 28 wt %)
Flame retardant: Vinyl silane coated Magnesium Hydroxide (MDH), BET 4.0-6.0,surface modified Aluminium Hydroxide (ATH), BET 3.0-5.0
Antioxidant: Tetrakis[β-(3,5-di-tert-butyl-4-hydroxyphenyl)propionate] pentaerythritol ester, pentaerythritol tetra (3-laurylthiopropionate)
Silicone gum: Polydimethylsiloxane (PDMS)
Cross-linking agent: Trimethylopropane Trimethacrylate (TMPTMA)

The content of each component in the examples is as shown in FIG. 1 and detailed as follows:

### EXAMPLE 1

Resin: 45 wt % of resin1, 35 wt % of resin3, 20 wt % of compatibilizer
Flame retardant: 110 parts by weight
Antioxidant: 2.5 parts by weight
Silicone gum: 5 parts by weight
Cross-linking agent: 3 parts by weight

### EXAMPLE 2

Resin: 50 wt % of resin2, 30 wt % of resin3, 20 wt % of compatibilizer
Flame retardant: 110 parts by weight
Antioxidant: 2.5 parts by weight
Silicone gum: 5 parts by weight

### EXAMPLE 3

Resin: 55 wt % of resin1, 30 wt % of resin3, 15 wt % of compatibilizer
Flame retardant: 110 parts by weight
Antioxidant: 2.5 parts by weight
Silicone gum: 5 parts by weight
Cross-linking agent: 3 parts by weight

On the other hand, constituents of comparative examples are as follows.

### COMPARATIVE EXAMPLE 1

Resin: 50 wt % of resin1, 45 wt % of resin3, 5 wt % of compatibilizer
Flame retardant: 100 parts by weight
Antioxidant: 2.5 parts by weight
Silicone gum: 2.5 parts by weight
Cross-linking agent: 3 parts by weight

### COMPARATIVE EXAMPLE 2

Resin: 45 wt % of resin1, 25 wt % of resin3, 5 wt % of compatibilizer
Flame retardant: 100 parts by weight
Antioxidant: 2.5 parts by weight
Silicone gum: 2.5 parts by weight
Cross-linking agent: 3 parts by weight

### COMPARATIVE EXAMPLE 3

Resin: 65 wt % of resin1, 15 wt % of resin3, 20 wt % of compatibilizer
Flame retardant: 100 parts by weight
Antioxidant: 2.5 parts by weight
Silicone gum: 5 parts by weight
Cross-linking agent: 3 parts by weight

### COMPARATIVE EXAMPLE 4

Resin: 45 wt % of resin1, 10 wt % of resin2, 15 wt % of resin3, 10 wt % of resin4, 20 wt % of compatibilizer
Flame retardant: 100 parts by weight
Silicone gum: 5 parts by weight
Cross-linking agent: 3 parts by weight

### COMPARATIVE EXAMPLE 5

Resin: 45 wt % of resin1, 10 wt % of resin2, 30 wt % of resin3, 15 wt % of compatibilizer
Flame retardant: 90 parts by weight
Antioxidant: 2.5 parts by weight
Cross-linking agent: 3 parts by weight

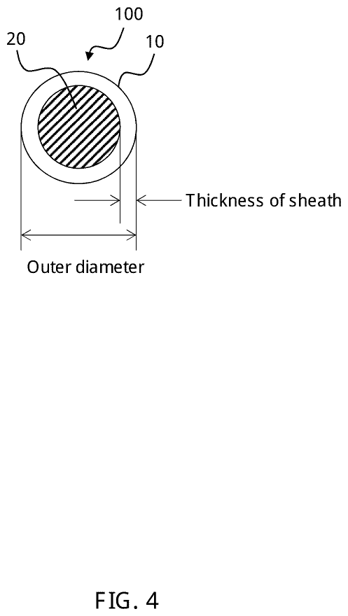

FIG. 4 illustrates a high-voltage cable 100 including an electrical conductor wire 20 and a sheath 10 according to an example of the present disclosure. FIGS. 1-3 show results of tests performed using cables, as illustrated in FIG. 4, made from materials in the examples and comparative examples.

The test results in FIG. 1 show that all of the examples and the comparative examples satisfy requirements for elongation (150% or more) and tensile strength 1.05 kgf/mm² or more). All of the examples and comparative examples satisfy the requirements for volume resistivity (10¹⁴ (2 mm or more) except for comparative example 3.

In terms of hardness, all of the examples satisfy the requirements (Shore D40 or less)., Comparative example 2 does not satisfy the requirements, and comparative example 4 barely satisfies the requirements.

In terms of heat resistance and oxygen index, all of the examples and the comparative examples satisfied the requirements.

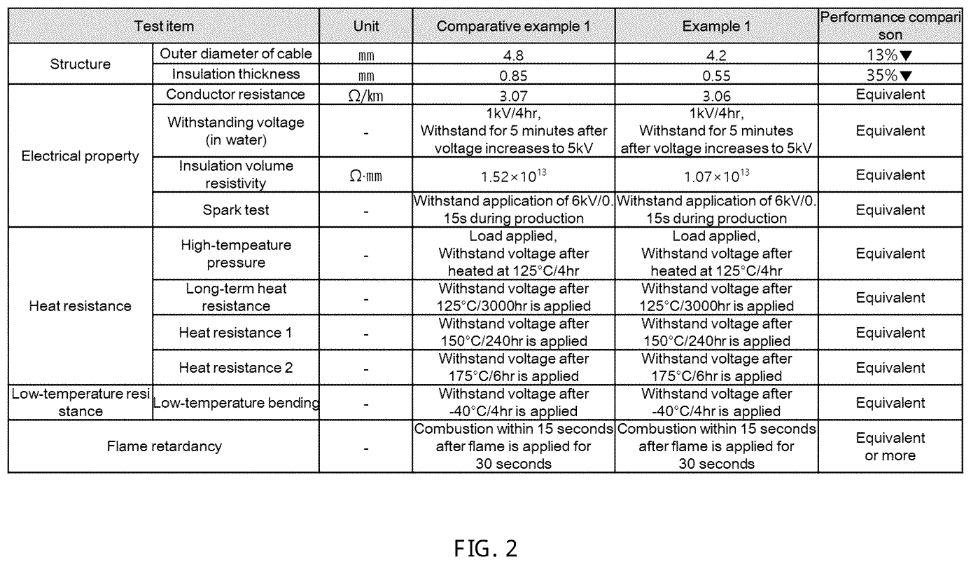

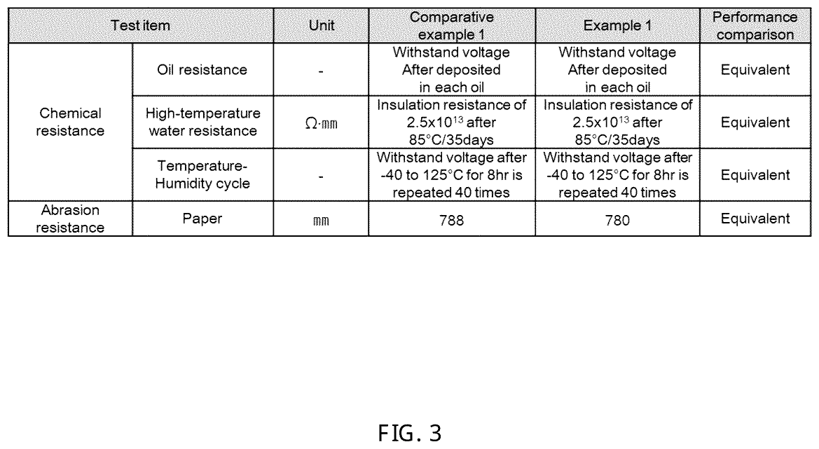

FIGS. 2 and 3 show the test results for example 1 and comparative example 1. Hereinafter, the test results will be described.

In terms of the insulation thickness, comparative example 1 has a thickness of 0.85 mm, and example 1 has a thickness of 0.55 mm. A cable made from a material of the example 1shows a 35% reduction in thickness.

Also, in terms of an outer diameter of the cable, comparative example 1 has an outer diameter of 4.8 mm, and example 1 has an outer diameter of 4.2 mm, which result in a 13% reduction in outer diameter.

Despite the reduction in insulation thickness and outer diameter, the example 1 cable shows the equivalent level as the comparative example 1 in terms of electrical properties, heat resistance, low-temperature resistance, and flame retardancy.

Referring to FIG. 3, the example 1 also shows the equivalent level as the comparative example 1 in terms of chemical resistance and abrasion resistance.

That is, it is known that the cable made from the material of the example 1 exhibits an effect of reduction in insulation thickness and outer diameter while maintaining the required properties equivalent to a cable made from a material of the comparative example 1.

The electrical cable made from the composition according to an example of the present disclosure may satisfy ISO 19642 conditions with an insulation thickness of less than 0.8 mm and/or an outer diameter of 4.5 mm or less.

A vehicle according to an example of the present disclosure may include a high-voltage battery and a high-voltage cable 100 electrically connected to the high-voltage battery.

For example, the vehicle according to this example may be an electric vehicle, and the high-voltage battery may supply high-voltage power to a drive motor that drives wheels.

The high-voltage battery may include a plurality of battery cells (not shown) that output a voltage in a range of 2.7 to 4.2 V. The plurality of battery cells may be connected in series and/or parallel in a predetermined number to form a single module. The high-voltage battery may be packaged into a single battery package as one or more battery modules are connected in series or parallel to output, e.g., about 400 V, about 800 V, or several kV.

As illustrated in FIG. 4, the high-voltage cable 100 includes an electrical conductor wire 20 and a sheath 10 that surrounds the electrical conductor wire.

The sheath 10 may be made from the above-described material of the example.

The present disclosure is intended to solve at least one of the above-described technical limitations.

The present disclosure provides a cross-linked polyethylene composition having excellent abrasion resistance and insulation resistance. The present disclosure also provides a high-voltage cable that satisfies the “thin wall insulation” specification of ISO 19642 by using the composition.

An example of the present disclosure provides an insulation composition for an electrical cable, wherein the insulation composition comprise a base resin, a flame retardant, a cross-linking agent and other additives, and wherein the base resin comprises about 30 to about 60 wt % of a polar ethylene-based copolymer, about 20 to about 50 wt % of ethylene-propylene rubber or ethylene alpha-olefin, and about 10 to about 20 wt % of ethylene-vinyl acetate modified with maleic anhydride.

In an example, the polar ethylene-based copolymer may include an ethylene copolymer containing about 15 to about 50 wt % of a polar monomer.

In an example, the polar ethylene-based copolymer may further include one or more of ethylene-butyl acrylate (EBA), ethylene-ethyl acrylate (EEA), and ethylene-vinyl acetate (EVA).

In an example, the ethylene alpha-olefin may be selected from a group including 1-butene, 1-octene, 1-pentene, 1-hexene, 1-heptene, 4-methyl-1-pentene, or 6-methyl-1-heptene.

In an example, the flame retardant may include a metal hydroxide or a phosphorus-based flame retardant.

In an example, the flame retardant may be the metal hydroxide.

In an example, the flame retardant may be contained in an amount of 50 to 150 parts by weight based on the base resin.

In an example, the cross-linking agent may be contained in an amount of 1 to 10 parts by weight based on the base resin.

In an example, the cross-linking agent may be contained in an amount of 1 to 5 parts by weight based on the base resin.

In an example, the other additives may include an antioxidant.

In an example, the antioxidant may include a phenol-based antioxidant.

In an example, the antioxidant may further include an amine-based or thioester-based antioxidant.

In an example, the other additives may include a slip agent.

In an example, the slip agent may include a condensation product of a fatty acid derivative and an organic siloxane, or a silicone gum.

In an example, the base resin may include 15-50 phr of polar ethylene-based copolymer resin, 20-50 phr of ethylene alpha-olefin resin, and 10-20 phr of ethylene-vinyl acetate resin modified with maleic anhydride, the flame retardant may include 50-100 phr of inorganic flame retardant, a content of the cross-linking agent may be 1-10 phr, and the other additives may include 2-5 phr of antioxidant and 1-5 phr of slip agent.

In an example of the present disclosure, a high-voltage cable includes an electrical conductor wire and a sheath that surrounds the electrical conductor wire. Here, the sheath is made from an insulation composition including a base resin, a flame retardant, a cross-linking agent, and other additives, and the base resin includes about 30 to about 60 wt % of a polar ethylene-based copolymer, about 20 to about 50 wt % of ethylene-propylene rubber or ethylene alpha-olefin, and about 10 to about 20 wt % of ethylene-vinyl acetate modified with maleic anhydride.

In an example, the sheath may have a thickness less than about 0.8 mm.

In an example, the high-voltage cable may have an outer diameter of 4.5 mm or less.

In an example of the present disclosure, a vehicle includes a high-voltage battery and a high-voltage cable electrically connected to the high-voltage battery. Here, the high-voltage cable includes an electrical conductor wire and a sheath that surrounds the electrical conductor wire, the sheath is made from an insulation composition including a base resin, a flame retardant, a cross-linking agent, and other additives, and the base resin includes about 30 to about 60 wt % of a polar ethylene-based copolymer, about 20 to about 50 wt % of ethylene-propylene rubber or ethylene alpha-olefin, and about 10 to about 20 wt % of ethylene-vinyl acetate modified with maleic anhydride.

In an example, the high-voltage cable may have an outer diameter of about 4.5 mm or less, and the sheath may have a thickness less than about 0.8 mm.

According to an example of the present disclosure, the insulation thickness of the cable may be reduced. The insulation thickness of the cable may be reduced from 0.8 mm to 0.5 mm while securing the equivalent properties.

According to an example of the present disclosure, the insulation resistance performance may be strengthened to secure the required electrical performance although the insulation thickness is reduced by applying the ethylene-based copolymer resin and the ethylene alpha-olefin resin with excellent volume resistivity,

Also, according to an example of the present disclosure, the extrudability is not degraded in comparison with the typical XLPE. although the thickness is reduced by the increase in silicone content.

Also, according to an example of the present disclosure, the increase in the content of the compatibilizer may satisfy the ISO requirements for abrasion resistance. That is, the ISO standard for abrasion resistance may be satisfied by improving the mechanical strength through the addition of the compatibilizer to increase the bonding strength between the resin and the flame retardant and by improving the dispersibility and the surface activity through the addition of the slip agent.

Also, according to an example of the present disclosure, the flame retardancy requirements may be satisfied although the insulation thickness decreases through the increase in the amount of the flame retardant.

Also, according to an example of the present disclosure, the ISO T3-level heat resistance may be secured by adding the high-heat-resistance antioxidant to strengthen the heat resistance performance.

What is claimed is:

1. An insulation composition for an electrical cable, the insulation composition comprising:
a base resin;
a flame retardant;
a cross-linking agent; and
at least one other additive, wherein the base resin comprises: 30 to 60 wt % of a polar ethylene-based copolymer, 20 to 50 wt % of ethylene-propylene rubber or ethylene alpha-olefin, and 10to 20 wt % of ethylene-vinyl acetate modified with maleic anhydride.

2. The insulation composition of claim 1, wherein the polar ethylene-based copolymer comprises an ethylene copolymer containing 15 to 50 wt % of a polar monomer.

3. The insulation composition of claim 1, wherein the polar ethylene-based copolymer comprises one or more of: ethylene-butyl acrylate (EBA), ethylene-ethyl acrylate (EEA), or ethylene-vinyl acetate (EVA).

4. The insulation composition of claim 1, wherein the ethylene alpha-olefin is one or more of 1-butene, 1-octene, 1-pentene, 1-hexene, 1-heptene, 1-methyl-1-pentene, or 6-methyl-1-heptene.

5. The insulation composition of claim 1, wherein the flame retardant comprises a metal hydroxide or a phosphorus-based flame retardant.

6. The insulation composition of claim 1, wherein the flame retardant comprises a metal hydroxide.

7. The insulation composition of claim 5, wherein the flame retardant is contained in an amount of 50 to 150 parts by weight per hundred parts by weight of the base resin.

8. The insulation composition of claim 1, wherein the cross-linking agent is contained in an amount of 1 to 10 parts by weight per hundred parts by weight of the base resin.

9. The insulation composition of claim 8, wherein the cross-linking agent is contained in an amount of 1 to 5 parts by weight per hundred parts by weight of the base resin.

10. The insulation composition of claim 1, further comprising an antioxidant as an additive.

11. The insulation composition of claim 10, wherein the antioxidant comprises a phenol-based antioxidant.

12. The insulation composition of claim 11, wherein the antioxidant further comprises at least one of: an amine-based or thioester-based antioxidant.

13. The insulation composition of claim 1, further comprising a slip agent as an additive.

14. The insulation composition of claim 13, wherein the slip agent comprises at least one of:
a condensation product of a fatty acid derivative and an organic siloxane, or a silicone gum.

15. The insulation composition of claim 1, wherein the base resin comprises 15-50 parts per hundred of the polar ethylene-based copolymer, 20-50 parts per hundred of the ethylene alpha-olefin, and 10-20 parts per hundred of the ethylene-vinyl acetate modified with maleic anhydride,
the flame retardant comprises 50-100 parts per hundred of inorganic flame retardant,
a content of the cross-linking agent in the insulation composition is 1-10 parts per hundred, and
further comprising:
2-5 parts per hundred of an antioxidant and
1-5 parts per hundred of a slip agent.

16. An electrical cable comprising:
an electrical conductor wire; and
a sheath that surrounds the electrical conductor wire,
wherein the sheath is made from an insulation composition comprising:
a base resin,
a flame retardant, and
a cross-linking agent,
wherein the base resin comprises 30 to 60 wt % of a polar ethylene-based copolymer, 20 to 50 wt % of ethylene-propylene rubber or ethylene alpha-olefin, and 10 to 20 wt % of ethylene-vinyl acetate modified with maleic anhydride.

17. The electrical cable of claim 16, wherein the sheath has a thickness less than 0.8 mm.

18. The electrical cable of claim 17, wherein the electrical cable has an outer diameter of 4.5 mm or less.

19. A vehicle comprising:
a battery; and
an electrical cable electrically connected to the battery,
wherein the electrical cable comprises an electrical conductor wire and a sheath that surrounds the electrical conductor wire,
wherein the sheath is made from an insulation composition comprising:
a base resin,
a flame retardant, and
a cross-linking agent,
wherein the base resin comprises 30 to 60 wt % of a polar ethylene-based copolymer, 20 to 50 wt % of ethylene-propylene rubber or ethylene alpha-olefin, and 10 to 20 wt % of ethylene-vinyl acetate modified with maleic anhydride.

20. The vehicle of claim 19, wherein the electrical cable has an outer diameter of 4.5 mm or less, and
wherein the sheath has a thickness less than 0.8 mm.
